(19) United States
(12) Patent Application Publication
(10) Pub. No.: US 2013/0087985 A1
(43) Pub. Date: Apr. 11, 2013

(54) MAGNETO-RHEOLOGICAL ELASTOMER-BASED VEHICLE SUSPENSION

(71) Applicant: Prabhakar R. Marur, Bangalore (IN)

(72) Inventor: Prabhakar R. Marur, Bangalore (IN)

(73) Assignee: GM GLOBAL TECHNOLOGY OPERATIONS LLC, Detroit, MI (US)

(21) Appl. No.: 13/253,147

(22) Filed: Oct. 5, 2011

(51) Int. Cl. B60G 11/22; F16F 6/00

(52) U.S. Cl. 280/124.177; 267/140.14

(57) ABSTRACT

A system for applying a force having variable intensity includes a magneto-rheological (MR) elastomer spring configured to generate the force and characterized by a selectively variable spring rate. The system also includes an electromagnet arranged relative to the MR elastomer spring and configured to generate a magnetic field having selectively variable intensity. The system additionally includes a power supply configured to generate an electric current sufficient to power the electromagnet. The spring rate of the MR elastomer spring is varied in response to the intensity of the magnetic field. A vehicle employing the above described system is also disclosed.

### TECHNICAL FIELD

The present disclosure relates to a magneto-rheological elastomer-based vehicle suspension.

### BACKGROUND

Contemporary on- and off-road going vehicles typically employ suspension systems that generally include a system of springs, shock absorbers, and linkages that connect a vehicle body to the vehicle's wheels. Because the majority of forces acting on the vehicle body are transmitted through contact patches between the road and the tires, one of the main objectives of a vehicle suspension is to maintain the contact between the vehicle's road wheels and the road surface.

Vehicle suspension systems generally contribute to the vehicle's road-holding/handling and braking for good active safety and driving pleasure, as well as provide comfort and reasonable isolation from road noise, bumps, and vibrations to the vehicle occupants. Because these objectives are generally at odds, the tuning of suspensions involves finding a compromise that is appropriate to each vehicle's intended purpose. For example, a suspension for a sporting vehicle may be tuned to give up some ride comfort in return for enhanced operator control, while a suspension for a luxury vehicle may be tuned for the opposite outcome.

### SUMMARY

A system for applying a force having variable intensity includes a magneto-rheological (MR) elastomer spring configured to generate the force and characterized by a selectively variable spring rate or stiffness. The system also includes an electromagnet arranged relative to the MR elastomer spring and configured to generate a magnetic field having selectively variable intensity. The system additionally includes a power supply configured to generate an electric current sufficient to power the electromagnet. The spring rate of the MR elastomer spring is varied in response to the intensity of the magnetic field.

The MR elastomer spring may be characterized by internal hysteresis such that the internal hysteresis may be varied in response to the intensity of the magnetic field.

The MR elastomer spring may be formed from one of a natural and a synthetic rubber compound and may have ferromagnetic particles suspended therein. The ferromagnetic particles may be formed from at least one of iron, nickel, cobalt, and manganese. Additionally, the MR elastomer spring may be cured while being subjected to an electromagnetic field.

The MR elastomer spring may be formed into a shape configured to generate the force in a predefined direction.

The system may additionally include a controller configured to regulate the flow of current from the power supply to the electromagnet.

A vehicle employing the above described system is also disclosed. The vehicle may include a plurality of dampers. In such a case, each of the plurality of dampers may be arranged in a substantially parallel load path to one MR elastomer spring and is configured to control the force generated by the respective MR elastomer spring.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic top view of a motor vehicle equipped with a suspension system including magneto-rheological (MR) elastomer springs;

FIG. 2 is close up perspective view of a portion of the suspension system of the vehicle shown in FIG. 1;

FIG. 3 is a schematic cross-sectional view of the MR elastomer spring shown in FIG. 2, illustrating a condition when the spring is not being subjected to a magnetic field;

FIG. 4 is a schematic cross-sectional view of the MR elastomer spring shown in FIG. 2, illustrating a condition when the spring is being subjected to a magnetic field;

FIG. 5 is an exemplary graphical plot of the change in internal stress of the MR elastomer spring at a particular strain in response to the change in the intensity of the applied magnetic field; and

FIG. 6 is an exemplary graphical plot of the change in internal hysteresis of the MR elastomer spring in response to the change in the intensity of the applied magnetic field.

### DETAILED DESCRIPTION

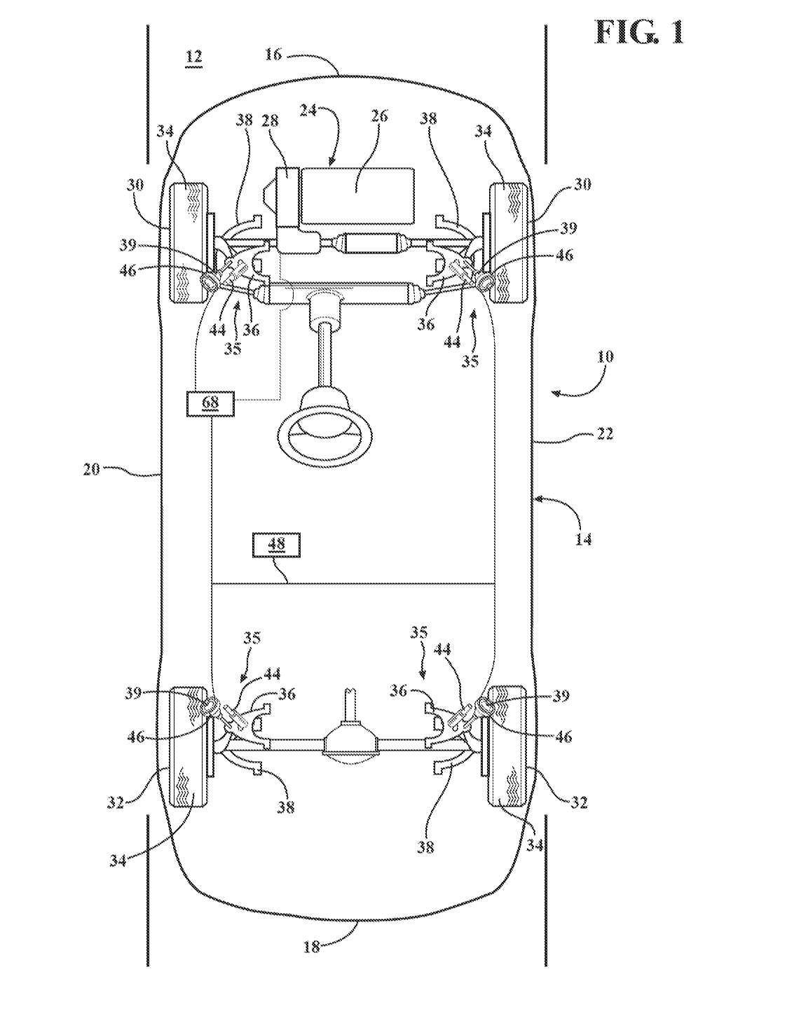

Referring to the drawings, wherein like reference numbers refer to like components, FIG. 1 shows a schematic view of a motor vehicle 10 positioned relative to a road surface 12. The vehicle includes a vehicle body 14. The vehicle body 14 defines four body sides. The four body sides include a front end 16, a rear end 18, a left side 20, and a right side 22.

The vehicle 10 also includes a powertrain 24 configured to propel the vehicle. As shown in FIG. 1, the powertrain 24 may include an engine 26 and a transmission 28. The powertrain 24 may also include one or more motor/generators as well as a fuel cell, neither of which are shown, but a powertrain configuration employing such devices is appreciated by those skilled in the art. The vehicle 10 also includes a plurality of wheels 30 and 32. Each of the plurality of wheels 30, 32 includes an inflatable tire 34 mounted thereon. Although four wheels 30, 32 with tires 34 are shown in FIG. 1, a vehicle with fewer or greater number of wheels and tires is also envisioned, for example having two wheels 30 at the front end 16 and one wheel 32 at the rear end 18. Depending on specific configuration of the powertrain 24, power of the engine 26 may be transmitted to the road surface 12 through the wheels 30, the wheels 32, or through all the wheels 30 and 32.

As shown in FIG. 1, a vehicle suspension system 35 operatively connects the body 14 to the wheels 30, 32 for maintaining contact between the wheels and a road surface, and for maintaining handling of the vehicle. As shown, the suspension system 35 may include an upper control arm 36 and a lower control arm 38, each connected to one of the wheels 30, 32. Although a specific configuration of the suspension system 35 is shown in FIG. 1, other vehicle suspension designs are similarly envisioned.

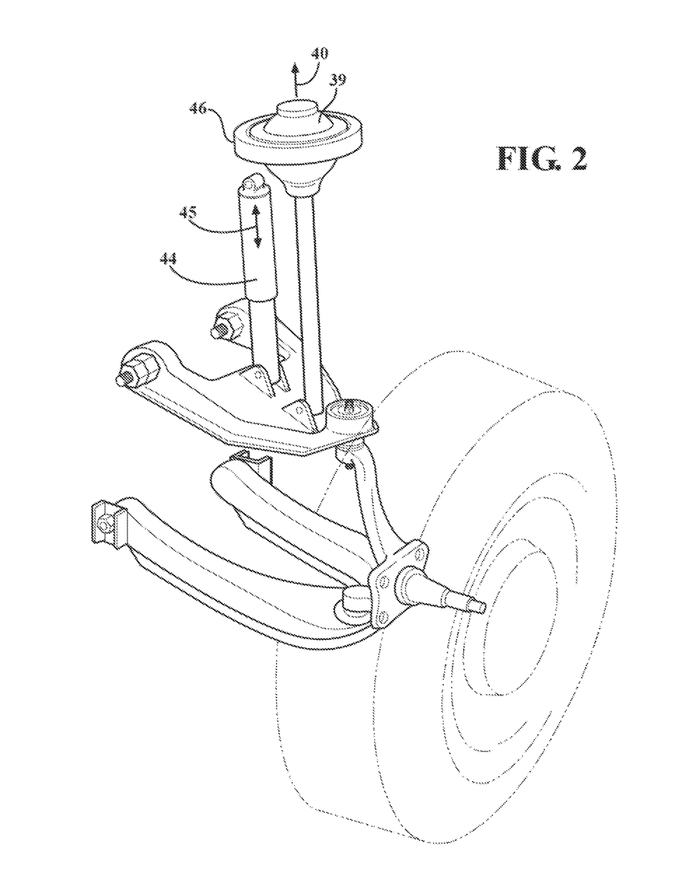

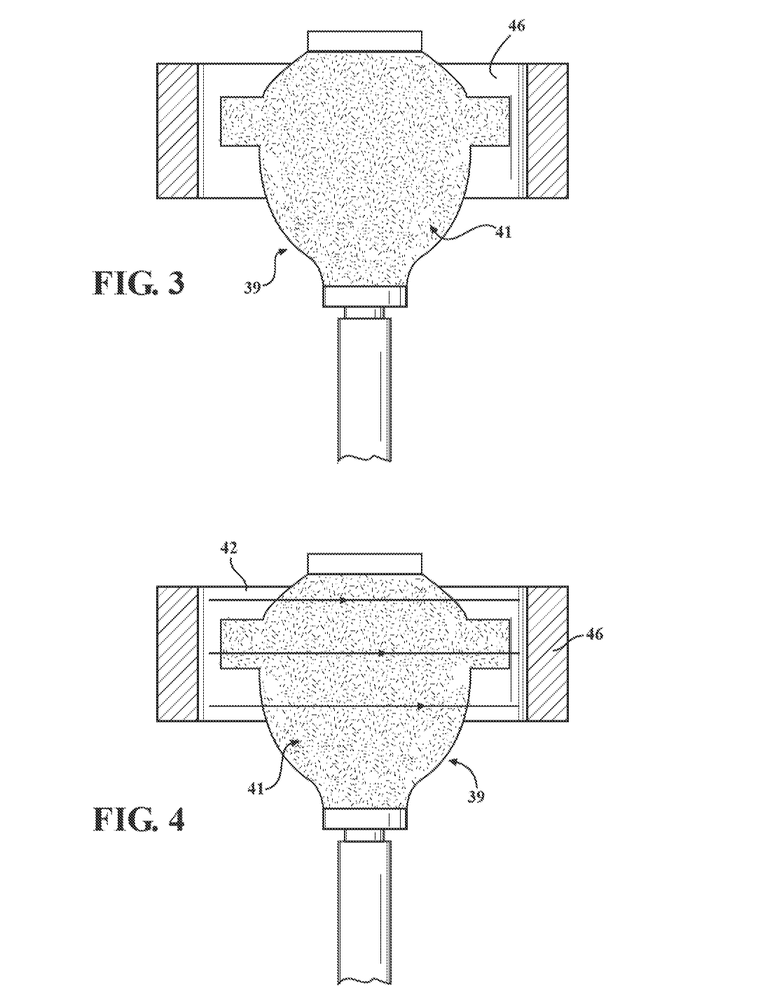

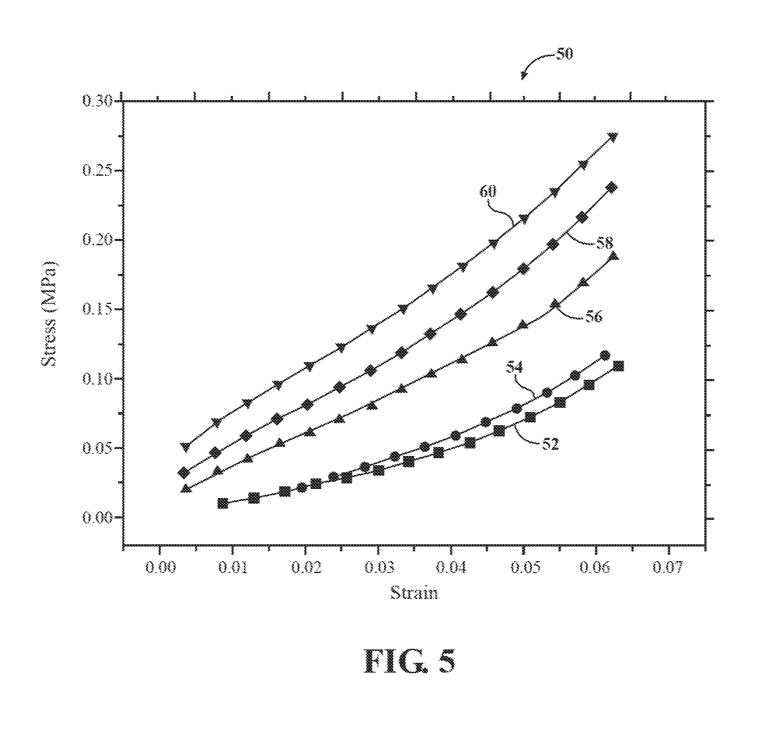

The suspension system 35 also includes magneto-rheological (MR) elastomer springs 39. Each MR elastomer spring 39 is configured to generate a force depicted by an arrow 40 (shown in FIG. 2) between one of the plurality of wheels 30, 32 and the vehicle body 14. Furthermore, each MR elastomer spring 39 is characterized by a selectively variable spring rate and a variable internal hysteresis. The MR elastomer spring 39 may be formed from either a natural or a synthetic rubber compound and includes ferromagnetic particles 41 suspended therein (shown in FIG. 3). The ferromagnetic particles 41 may be formed from a material that may be affected by an electromagnetic field 42 (shown in FIG. 4) generated proximately to the MR elastomer spring 39, for example iron, nickel, cobalt, or manganese.

As shown in FIG. 2, the MR elastomer spring 39 may be formed into a shape configured to generate the force in a predefined direction. The MR elastomer spring 39 shown in FIG. 2 has a substantially conical shape configured to generate a predetermined variable force even prior to being subjected to the electromagnetic field 42. After the rubber compound has been impregnated with the ferromagnetic particles 41, the resultant compound may be cured into the desired shape while being subjected to an electromagnetic field of predetermined intensity. Such an application of an electromagnetic field may be used to pre-align the ferromagnetic particles 41 in the direction that generates a desired initial stiffness or spring rate of the MR elastomer spring 39.

As noted above, the MR elastomer spring 39 is characterized by internal hysteresis which generates damping that may be used to control the compression and rebound properties of the MR elastomer spring. Furthermore, the internal hysteresis of the MR elastomer spring 39 may be varied in response to the applied electromagnetic field 42. Such internal hysteresis may, however, be insufficient to generate the sought response of the suspension system 35 in all operating situations. Accordingly, in addition to the MR elastomer springs 39 the suspension system 35 may include a plurality of hydraulic or gas dampers 44 (shown in FIGS. 1 and 2). As shown in FIG. 2, each damper 44 may be arranged in a load path 45 that is substantially parallel to the force 40 of one MR elastomer spring 39, and is configured to control the force 40 generated by the respective MR elastomer spring.

As shown in FIGS. 1-4, the vehicle 10 also includes a plurality of electromagnets 46. Each electromagnet 46 is arranged relative to each MR elastomer spring 39 and configured to generate the magnetic field 42 having selectively variable intensity. Additionally, the vehicle 10 includes a power supply 48 (shown in FIG. 1) configured to generate an electric current sufficient to power the electromagnet 46. The power supply 48 may be configured as a typical 12 volt vehicle battery that is capable of providing 1-2 Amps of electrical current. Such magnitude of current is typically sufficient to generate a magnetic field 42 having a magnitude of 2 Tesla.

FIG. 3 depicts a schematic cross-sectional view of the MR elastomer spring 39 when the spring is not being subjected to the magnetic field 42. As may be seen from FIG. 3, the ferromagnetic particles 41 are suspended within the body of the MR elastomer spring 39 but generate no internal stress. FIG. 4 depicts a schematic cross-sectional view of the MR elastomer spring 39, illustrating a condition when the spring is being subjected to the magnetic field 42. As may be seen from FIG. 4, the magnetic field 42 acts on the ferromagnetic particles 41 within the body of the MR elastomer spring 39 in the direction of the generated magnetic flux. Accordingly, in attempting to align with the magnetic flux, the ferromagnetic particles 41 generate stress within the body of the MR elastomer spring 39 and increase the spring's stiffness and its internal hysteresis.

FIG. 5 depicts an exemplary graphical plot 50 of the change in internal stress of the of the MR elastomer spring 39 at a particular strain in response to the change in the intensity of the applied magnetic field 42. Accordingly, stress-strain curves 52, 54, 56, 58, and 60 shown on the plot 50 represent the change in the stiffness of the MR elastomer spring as the spring is subjected to the magnetic field 42 of varied intensity. The stress-strain curve 52 represents a situation when the intensity of the magnetic field 42 is zero. The stress-strain curve 54 represents a situation when the intensity of the magnetic field 42 is 0.18 Tesla, and the stress-strain curve 56 represents a situation when the intensity of the magnetic field is 0.35 Tesla. The stress-strain curve 58 represents a situation when the intensity of the magnetic field 42 is 0.68 Tesla, and the stress-strain curve 60 represents a situation when the intensity of the magnetic field is 1.0 Tesla. As may be seen from the plot 50, application of the magnetic field 42 proportionately increases the internal stress of the MR elastomer spring 39 from zero to approximately 0.05 MPa even without any external load applied to the spring. Furthermore, an application of the magnetic field 42 having a magnitude of 1.0 Tesla may be sufficient to generate an increase in the internal stress of the MR elastomer spring 39 from approximately 0.1 MPa to approximately 0.27 MPa at a strain of 0.06.

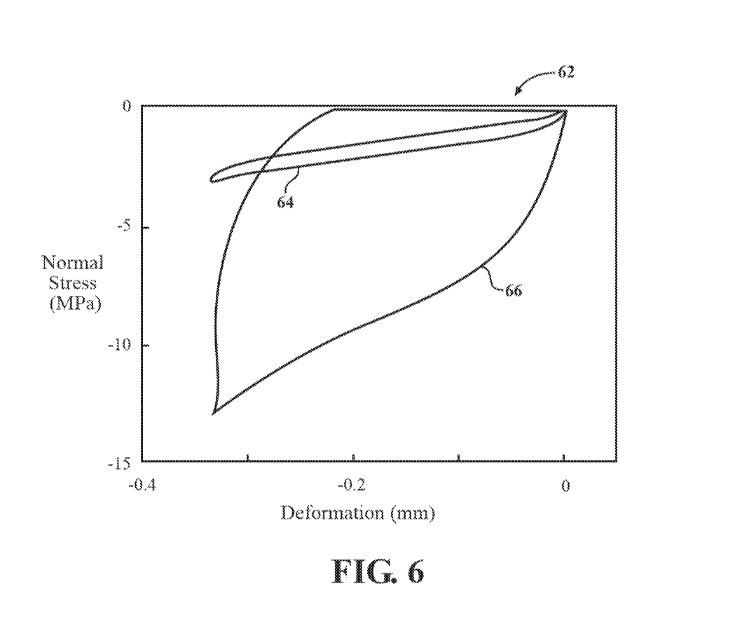

FIG. 6 depicts an exemplary graphical plot 62 of the change in internal hysteresis of the MR elastomer spring 39 in response to the change in the intensity of the applied magnetic field 42. The area enclosed by the hysteresis curve of is a measure of the internal friction and the resultant internal damping of the MR elastomer spring 39 that is generated as the material undergoes elastic deformation under an external load. As shown in FIG. 6, an application of a magnetic field 42 proportionately increases the internal hysteresis of the MR elastomer spring 39, wherein a curve 64 represents the spring hysteresis when the magnetic field 42 is zero and a curve 66 represents the spring hysteresis at the magnetic field 42 equivalent to 0.3 Tesla.

With resumed reference to FIG. 1, a controller 68 may be arranged on the vehicle 10 and configured to regulate the flow of current from the power supply 48 to the electromagnets 46. The controller 68 may be programmed to vary the spring rate and the internal hysteresis of the MR elastomer spring 39 via regulating the intensity of the magnetic field 42 generated by the electromagnets 46. The controller 68 may be a standalone, dedicated electronic processor, or an electronic control unit that is primarily configured to regulate the operation of the vehicle powertrain 24, as well as the vehicle's braking and stability control systems (not shown). Accordingly, the controller 68 may be programmed to coordinate regulation of the spring rate and the internal hysteresis of the MR elastomer spring 39 with operation of the powertrain, braking, and stability control systems to more effectively influence dynamic behavior of the vehicle 10.

While the best modes for carrying out the invention have been described in detail, those familiar with the art to which this invention relates will recognize various alternative designs and embodiments for practicing the invention within the scope of the appended claims.

1. A vehicle comprising:
a vehicle body;
a plurality of wheels for maintaining contact with a road surface; and
a vehicle suspension system connecting the plurality of wheels to the vehicle body, the suspension system including:
a magneto-rheological (MR) elastomer spring configured to generate a force between at least one of the plurality of wheels and the vehicle body and characterized by a selectively variable spring rate;
an electromagnet arranged relative to the MR elastomer spring and configured to generate a magnetic field having selectively variable intensity; and
a power supply configured to generate an electric current sufficient to power the electromagnet;
wherein the spring rate of the MR elastomer spring is varied in response to the intensity of the magnetic field.

2. The vehicle of claim 1, wherein the plurality of wheels is four and one MR elastomer spring is arranged proximately to each wheel.

3. The vehicle of claim 2, further comprising a plurality of dampers, wherein each of the plurality of dampers is arranged in a substantially parallel load path to one MR elastomer spring and is configured to control the force generated by the respective MR elastomer spring.

4. The vehicle of claim 1, wherein the MR elastomer spring is characterized by internal hysteresis, and wherein the internal hysteresis is varied in response to the intensity of the magnetic field.

5. The vehicle of claim 1, wherein the MR elastomer spring is formed from one of a natural and a synthetic rubber compound and includes ferromagnetic particles suspended therein.

6. The vehicle of claim 5, wherein the MR elastomer spring is cured while being subjected to an electromagnetic field.

7. The vehicle of claim 5, wherein the ferromagnetic particles are formed from at least one of iron, nickel, cobalt, and manganese.

8. The vehicle of claim 1, wherein the MR elastomer spring is formed into a shape configured to generate the force in a predefined direction.

9. The vehicle of claim 1, further comprising a controller configured to regulate the flow of current from the power supply to the electromagnet.

10. A system for applying a force having variable intensity, the system comprising:
a magneto-rheological (MR) elastomer spring configured to generate the force and characterized by a selectively variable spring rate;
an electromagnet arranged relative to the MR elastomer spring and configured to generate a magnetic field having selectively variable intensity; and
a power supply configured to generate an electric current sufficient to power the electromagnet;
wherein the spring rate of the MR elastomer spring is varied in response to the intensity of the magnetic field.

11. The system of claim 10, wherein the MR elastomer spring is characterized by internal hysteresis which is varied in response to the intensity of the magnetic field.

12. The system of claim 10, wherein the MR elastomer spring is formed from one of a natural and a synthetic rubber compound having ferromagnetic particles suspended therein.

13. The system of claim 12, wherein the MR elastomer spring is cured while being subjected to an electromagnetic field.

14. The system of claim 12, wherein the ferromagnetic particles are formed from at least one of iron, nickel, cobalt, and manganese.

15. The system of claim 10, wherein the MR elastomer spring is formed into a shape configured to generate the force in a predefined direction.

16. The system of claim 10, further comprising a controller configured to regulate the flow of current from the power supply to the electromagnet.

17. A vehicle comprising:
a vehicle body;
a plurality of wheels for maintaining contact with a road surface; and
a vehicle suspension system connecting the plurality of wheels to the vehicle body, the suspension including:
a magneto-rheological (MR) elastomer spring configured to generate a force between each of the plurality of wheels and the vehicle body and characterized by a selectively variable spring rate and internal hysteresis;
an electromagnet arranged relative to the MR elastomer spring and configured to generate a magnetic field having selectively variable intensity;
a power supply configured to generate an electric current sufficient to power the electromagnet; and
a controller configured to regulate the flow of current from the power supply to the electromagnet;
wherein:
the MR elastomer spring is formed into a shape configured to generate the force in a predefined direction; and
the spring rate of the MR elastomer spring and the internal hysteresis are each varied in response to the intensity of the magnetic field.

18. The vehicle of claim 17, further comprising a plurality of dampers, wherein each of the plurality of dampers is arranged in a substantially parallel load path to one MR elastomer spring and is configured to control the force generated by the respective MR elastomer spring.

19. The vehicle of claim 17, wherein the MR elastomer spring is formed from one of a natural and a synthetic rubber compound having ferromagnetic particles suspended therein.

20. The vehicle of claim 19, wherein the MR elastomer spring is cured while being subjected to an electromagnetic field.
